(19) United States
(12) Patent Application Publication
(10) Pub. No.: US 2011/0049267 A1
(43) Pub. Date: Mar. 3, 2011

(54) VARIABLE FLUID FLOW IN AIR-OPERATED TWO COMPONENT GUN APPLICATOR

(76) Inventors: Joseph E. Tix, Hastings, MN (US); Christopher J. Pellin, Burnsville, MN (US); Mark T. Weinberger, Mounds View, MN (US); Jeffrey N. Velgersdyk, Minneapolis, MN (US); Douglas S. Ryder, St. Michael, MN (US)

(21) Appl. No.: 12/676,942

(22) PCT Filed: Sep. 11, 2008
(86) PCT No.: PCT/US08/75959

§ 371 Date: Mar. 8, 2010

Related U.S. Application Data
(60) Provisional application No. 60/971,300, filed on Sep. 11, 2007.

(51) Int. Cl. B05B 7/04

(52) U.S. Cl. 239/398

(57) ABSTRACT

A two component spray gun with low/high flow rates allows the operator to spray in confined areas at lower flow without having to change the mix module. The lower flow reduces undesirable “spray back” and will also help reduce material waste. Pneumatic piston 12 travel, which determines on/off fluid flow, can be selected on the fly to either close the fluid ports 14 which stops fluid flow, partially open the fluid ports 14 which limits fluid flow, or to fully open the fluid ports 14 to allow for maximum flow. Pneumatic piston 12 travel can be limited by means of a simple multi-position mechanical stop plunger 16. The stop bar 22 can be connected to a knob 18 or other operator input and turned or adjusted to the desired position

### TECHNICAL FIELD

This application claims the benefit of U.S. Application Ser. No. 60/971,300, filed Sep. 11, 2007, the contents of which are hereby incorporated by reference.

### BACKGROUND ART

Spray guns for applying plural component materials such as fast set foams are well known.

### DISCLOSURE OF THE INVENTION

The instant invention allows the operator to spray two component materials at variable flow rates. Pneumatic piston travel, which determines on/off fluid flow, can be selected on the fly to either close the fluid ports which stops fluid flow, partially open the fluid ports which limits fluid flow, or to fully open the fluid ports to allow for maximum flow. Pneumatic piston travel can be limited by means of a simple multi-position mechanical stop. The stop can be connected to a knob or other operator input and turned or adjusted to the desired position for the corresponding closed, partial, or full flow. Furthermore, the selectable piston travel design incorporates fine-tune adjustment for the partially open position. This feature allows the operator to decide how much to limit the flow in the partially open position.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the piston travel stop mechanism in the off position.

FIG. 2 shows the piston travel stop mechanism in the partially open position.

FIG. 3 shows the piston travel stop mechanism in the fully open position.

FIG. 4 shows the variable stop positions on the air cylinder cap.

FIG. 5 shows the applicator in the off position.

FIG. 6 shows the applicator in the partially open position.

FIG. 7 shows the applicator in the fully open position.

### BEST MODE FOR CARRYING OUT THE INVENTION

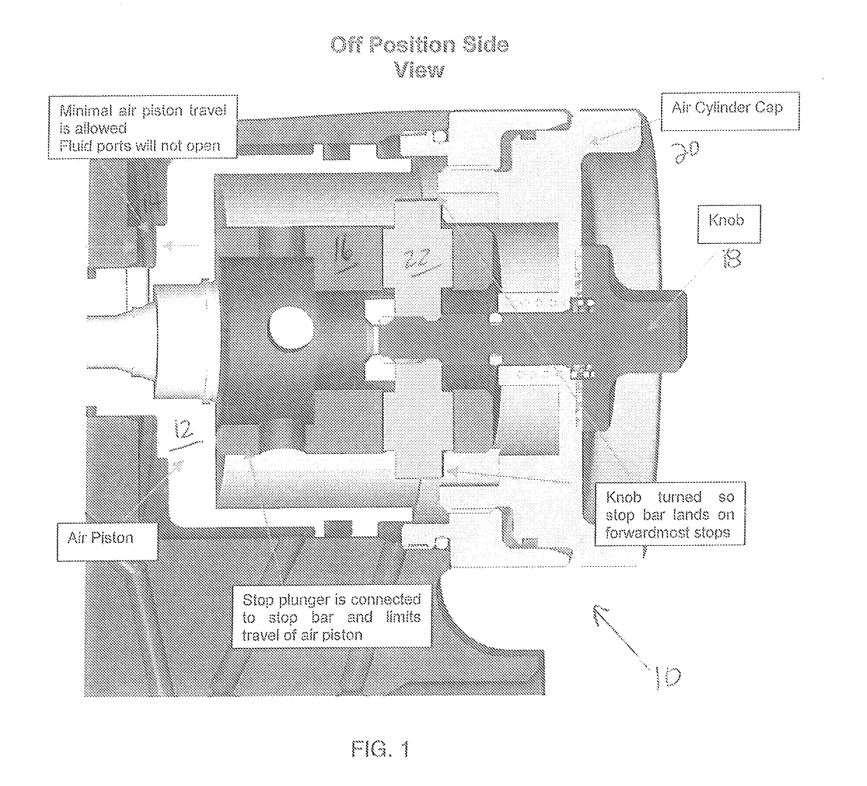

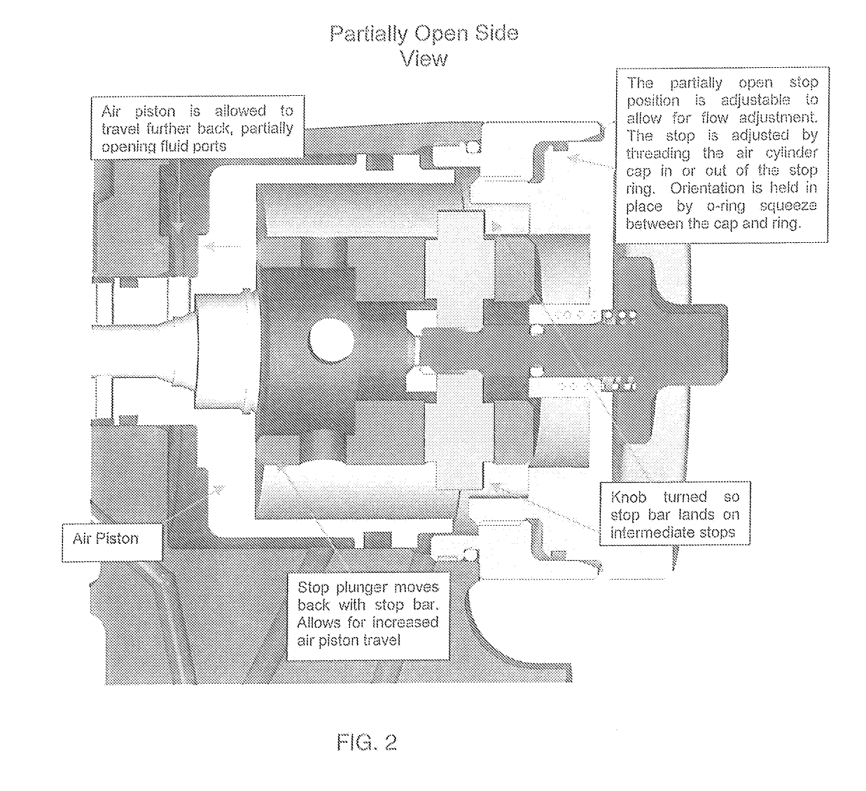

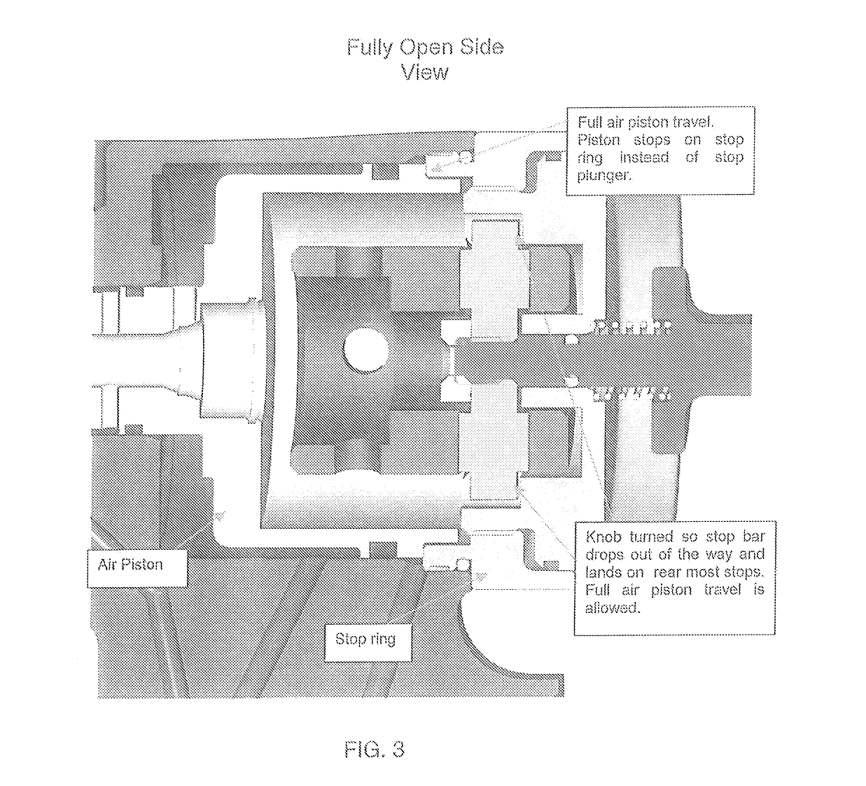

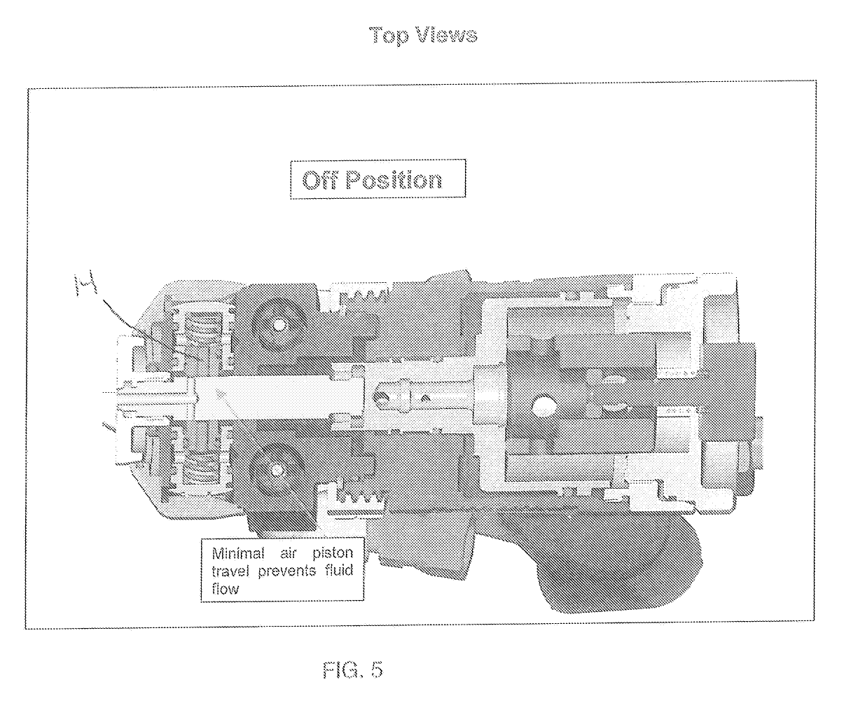

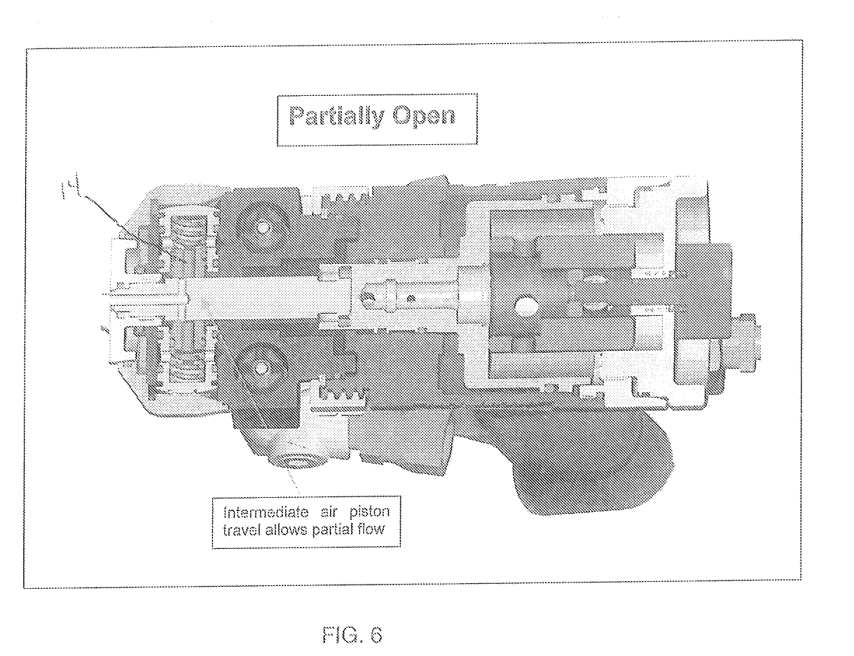

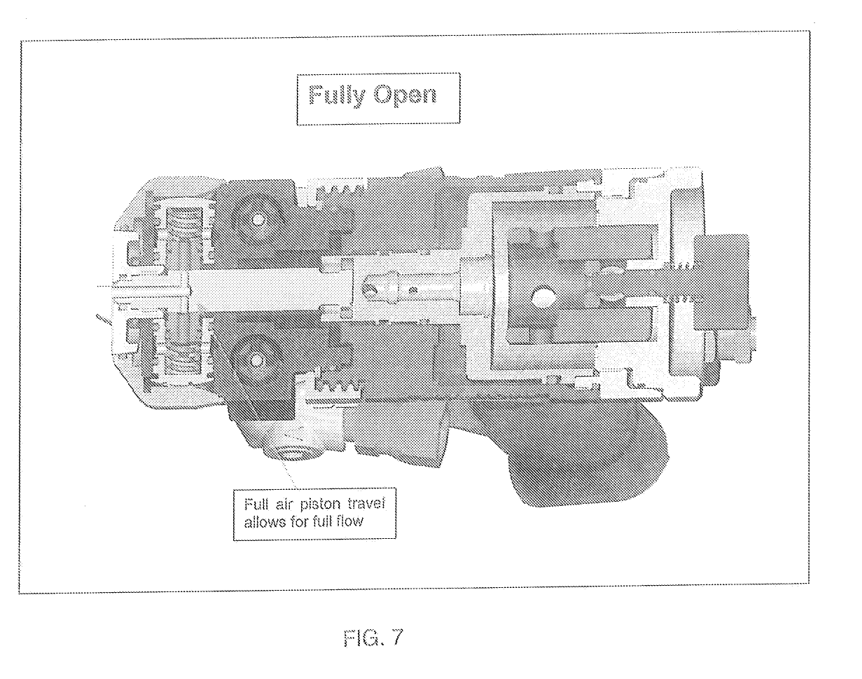

The instant invention 10 allows the operator to spray two component materials at variable flow rates. Pneumatic piston 12 travel, which determines on/off fluid flow, can be selected on the fly to either close the fluid ports 14 (see FIGS. 1 and 5) which stops fluid flow, partially open the fluid ports 14 which limits fluid flow (see FIGS. 2 and 6), or to fully open the fluid ports 14 (see FIGS. 3 and 7) to allow for maximum flow. Pneumatic piston 12 travel can be limited by means of to simple multi-position mechanical stop plunger 16. The stop bar 22 can be connected to a knob 18 or other operator input and turned or adjusted to the desired position for the corresponding closed, partial, or full flow to position the stop bar plunger 16 accordingly.

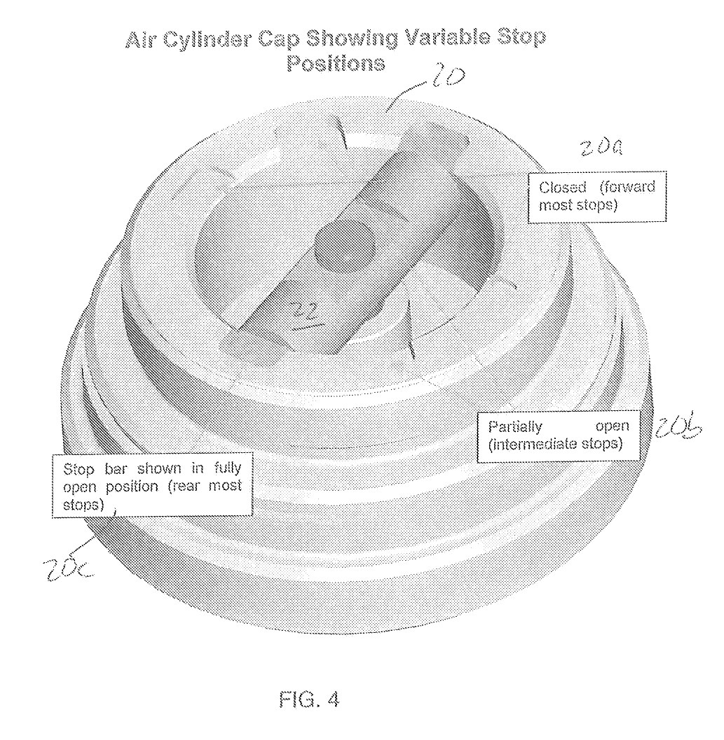

Furthermore, the selectable piston travel design incorporates fine-tune adjustment for the partially open position. The air cylinder cap 20 is threadedly adjustable in and out to vary the partially open/low flow position. This feature allows the operator to decide how much to limit the flow in the partially open position. FIG. 4 shows the air cylinder cap 20 having variable depth notches 20a, 20b and 20c for positioning the stop bar plunger 22 in the closed, partially open and fully open positions respectively.

It is contemplated that various changes and modifications may be made to the variable flow plural component applicator without departing from the spirit and scope of the invention as defined by the following claims.

1. A plural component spray gun having fluid ports, the improvement comprising:
a pneumatic piston positioned to selectively cover said fluid ports and movably between a closed position preventing flow through said ports, a partially open position allowing a limited amount of flow through said ports and an fully open position allowing full flow though said ports;
a mechanical stop plunger selectively positionable to limit travel of said piston to one of said positions; and
an operator positionable knob to selectively position said stop plunger.

2. The plural component spray gun of claim 1 further comprising a housing and an air cylinder cap threadedly engaged in said housing, said air cylinder cap being positionable to adjust the flow in said partially open position.
